(19) United States
(12) Patent Application Publication
(10) Pub. No.: US 2009/0284030 A1
(43) Pub. Date: Nov. 19, 2009

(54) SYSTEM AND METHOD FOR CONNECTING ATTACHMENTS TO A VEHICLE

(76) Inventor: Gary Rein, New York, NY (US)

Correspondence Address: KEITH D. NOWAK, CARTER LEDYARD & MILBURN LLP, 2 WALL STREET, NEW YORK, NY, 10005, US

(21) Appl. No.: 12/417,995

(22) Filed: Apr. 3, 2009

Related U.S. Application Data
(63) Continuation-in-part of application No. 12/183,172, filed on Jul. 31, 2008.
(60) Provisional application No. 61/053,234, filed on May 15, 2008.

(51) Int. Cl. B60R 19/44; G09F 21/04; F16D 1/00; A47B 37/04

(52) U.S. Cl. 293/142; 40/591; 403/16; 403/20; 108/44

(57) ABSTRACT

The present invention is directed to a system and method for connecting attachments to a vehicle, which generally includes a first piece and a second piece depending thereon. The first piece is a locator piece connected to the vehicle adjacent the license plate or the trunk of a vehicle. For instance, the first piece may be secured or locked to a license plate using a locking mechanism, which includes a cam and rods. In another embodiment, the first piece may be a support bracket dimensioned and configured to rest over a rim of a trunk without interfering with the normal functions of a lock on the trunk. The second piece can include a variety of devices such as and not limited to a bumper guard or a tray. The second piece may depend from and be removably connected to the first piece. By the second piece being removably connectable to the first piece, the second piece can be easily replaced when damaged or worn or interchanged. For instance, the bumperguard embodiment that serves to protect the bumper of a vehicle can be interchanged for the tray when at a tailgating event. The bumper guard or platform tray can be easily attached to the vehicle, stored and removed.

### PRIORITY AND RELATED APPLICATION

This is a continuation-in-part of U.S. patent application Ser. No. 12/183,172 filed Jul. 31, 2008, in the name of Gary Rein, and entitled SYSTEM AND METHOD FOR CONNECTING ATTACHMENTS TO A VEHICLE, which further claims priority to U.S. Provisional Patent Application Ser. No. 61/053,234, filed May 15, 2008, entitled “BUMPER GUARD,” which is hereby incorporated by reference in its entirety.

### FIELD OF THE INVENTION

The present invention relates to a system and method for connecting attachments to a vehicle, including a bumper guard for motor vehicle bumpers, as well as other modular attachments to the rear of the vehicle.

### BACKGROUND OF THE INVENTION

The majority of today's vehicles have integral colored single-piece thermoplastic covers over their bumpers that are particularly vulnerable to indentation. Current design aesthetics, as well as cost efficiencies have eliminated the use of secondary protective chrome, or rubber trims, that would normally serve to reduce the indentations and abrasions from the low impact hits that leave permanent impressions on the rear bumper. Our urban environments do little to protect motor vehicle bumpers. For instance, in garages, there is a tendency to compress as many cars as possible into a limited space by making direct contact between front and rear bumpers of adjacent vehicles. The resulting damage usually occurs from the bolts of the front license plate becoming embedded into the rear bumper of the next car. A bumper guard is needed that easily protects bumpers, including rear bumpers, of most motor vehicles such as recent model vehicles. In addition, by creating the attachment device to secure the Bumper Guard to the vehicle, alternative products can be attached that enhance the life cycle and usability of the product.

### BRIEF SUMMARY OF THE INVENTION

The system and method of connecting attachments to the vehicle generally has a first piece and a second piece depending thereon. The first piece is a locator piece connected to the vehicle adjacent the license plate or the trunk of a vehicle. For instance, the first piece may be secured or locked to a license plate using a locking mechanism, which includes a cam and rods. In another embodiment, the first piece may be a support bracket dimensioned and configured to rest over a rim of a trunk without interfering with the normal functions of a lock on the trunk. The second piece can include a variety of devices such as and not limited to a bumper guard or a tray. The second piece may depend from and be removably connected to the first piece. By the second piece being removably connectable to the first piece, the second piece can be easily replaced when damaged or worn or interchanged. For instance, the bumperguard embodiment that serves to protect the bumper of a vehicle can be interchanged for the tray when at a tailgating event. The bumper guard or platform tray can be easily attached to the vehicle, stored and removed.

### BRIEF DESCRIPTION OF THE DRAWINGS

FIG. 1 is an environmental perspective view of a first embodiment of the present invention.

FIG. 2 shows an exploded view of the bumper guard of the present invention.

FIG. 3 shows a locking mechanism of the bumper guard of the present invention.

FIG. 4 shows a second embodiment of the present invention.

FIG. 5 shows an alternate second embodiment of the present invention.

FIG. 6A shows a third alternate embodiment of the present invention disposed on a vehicle.

FIG. 6B shows an exploded view of the embodiment shown in FIG. 6A.

FIG. 7 shows the locator device shown in FIGS. 6A and 6B.

FIG. 8 shows the third alternate embodiment disposed on the vehicle with a lid of the vehicle open.

### DETAILED DESCRIPTION OF THE INVENTION

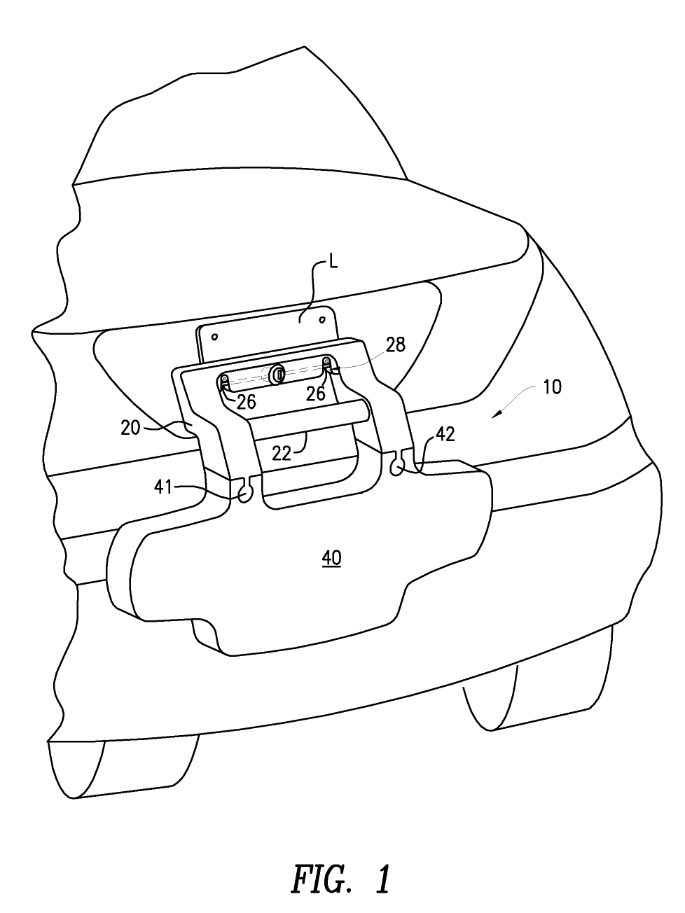

FIG. 1 shows a bumper guard 10 of the present invention attached to a rear end of a vehicle. The bumper guard 10 includes two pieces, a first piece or bumper guard locator 20 and a second piece or bottom piece 40. The first piece or locator 20 has a handle 22, grooves 28 and a locking mechanism including cam 24 and rods 26. The handle 22 may be integrated in the locator 20 and facilitates installation and removal of the guard 10. The second piece or bottom piece 40 depends from the locator 20. A pair of “T's” 41, 42 are molded in to the first piece locator 20, onto which the second piece 40 is connected to create a “modular connection system” for additional elements to depend from.

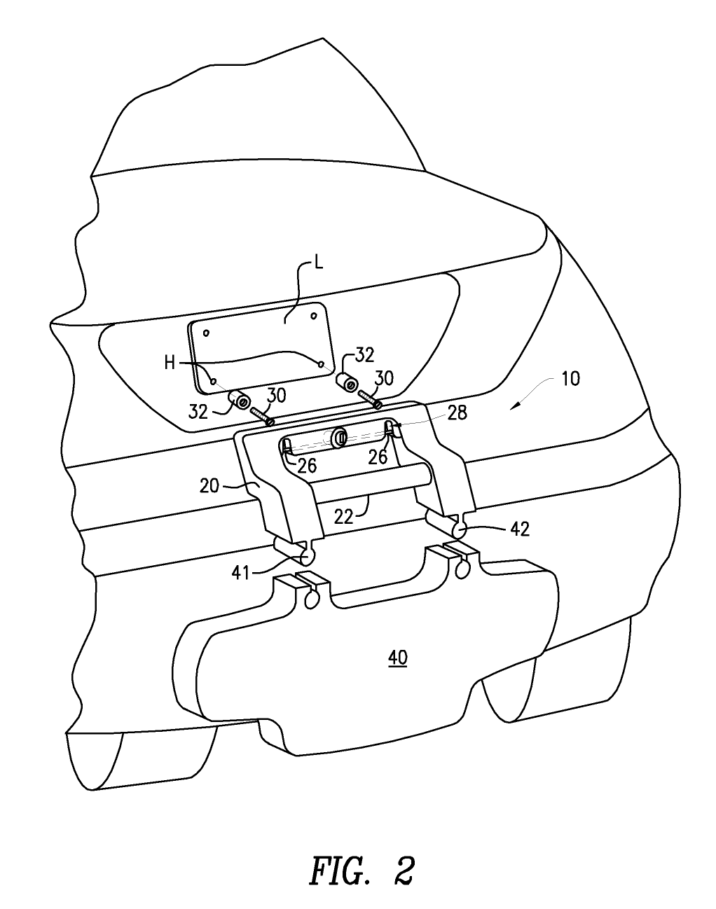

FIG. 2 shows an exploded view of the guard 10. Sleeves 32 connect to the rear of a vehicle through holes H of license plate L. Specifically, the sleeves 32 are dimensioned and configured to fit over screws 30, the sleeves 32 then fit or screw into holes H via the screws 30. In some embodiments, the sleeves 32 may be designed to screw directly into the holes H and replace the screws 30. The sleeves 32 may be made of plastic, such as polycarbonate, or other suitable material. The sleeves 32 have a tapered lead-in shape that are dimensioned and configured to the grooves 28 of the locator 20. The grooves 28 of the first piece or locator 20 align with the sleeves 32 that are disposed in holes H of the license plate L. In an alternative embodiment, the sleeves are integral into a separate license plate holder, providing the same method of attachment as with the separate sleeves. Thus, the sleeves 32 and the grooves 28 easily align with each other allowing the locator or first piece 20 to slide over or on the sleeves 32. A user may use the handle 22 to help place the locator 20 over the sleeves 32 since the handle 22 is in close proximity to the point of alignment.

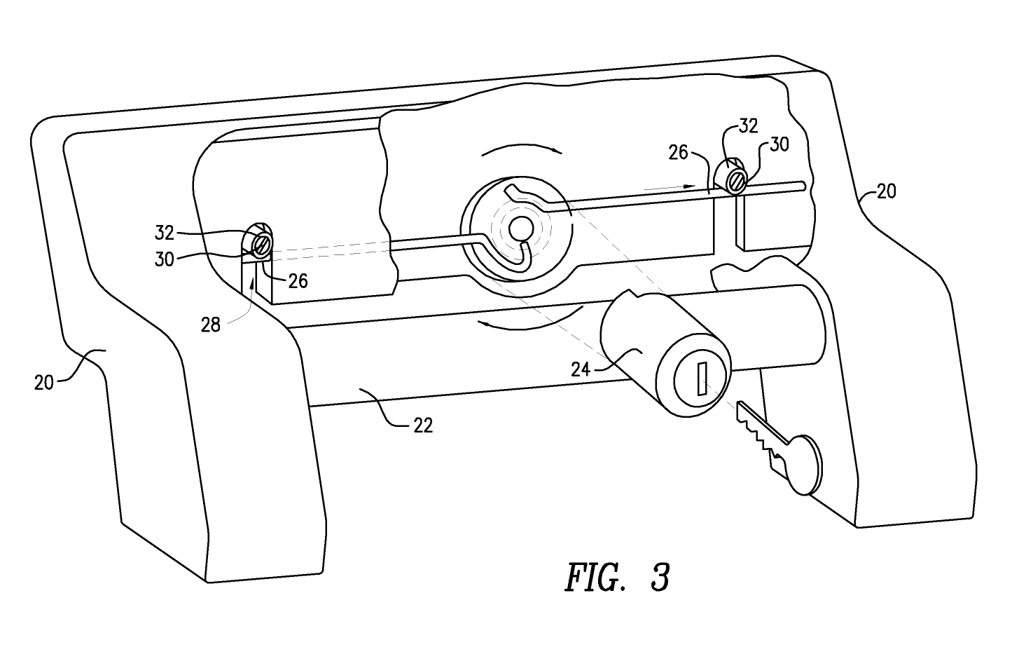

Referring now to FIG. 3, once the locator 20 is placed on the sleeves 32, the cam 24 and rods 26 of the locking mechanism is used to lock the guard 10 in place. The cam 24 and rods 26 cooperate with sleeves 32 to secure the guard 10. For instance, after the locator 20 is disposed on the sleeves 32, the user locks or secures the locator 20 by rotating the cam 24 with a key and extending the rods 26 into a generally linear arrangement. The rods 26 are dimensioned and configured to slide under and past the tapered part of the sleeves 32. In the extended position, the rods 26 slide past the sleeves 32 and either enter apertures located in or abut inner walls of the locator 20. The locking mechanism prevents theft, dislodging, or “riding-up” of the bumper guard 10 when being compressed by another vehicle. In some embodiments, the cam 24 may be off-center. Cam 24 and rods 26 may be made of steel or other suitable material.

As shown in the figures, the bottom piece 40 rests over the vehicles rear bumper and serves to deflect damage and protect the bumper. In addition, in an alternative embodiment, the first piece 20 is used as a method for attachment of an alternative second or bottom piece 44.

The molded “T” sections 41, 42 allow for the locator 20 and the bottom piece 40 to be removably attached. The bottom piece 40 therefore can be removed from the locator 20 and replaced if damaged or worn. The bottom piece 40 may be customized for size or shape, and product updates, or to accommodate different types of vehicles. The bottom piece 40 may be made of a variety of materials and may have any thicknesses. Some embodiments may also have various coatings for protection from the elements or to provide firmness. In one example, the bottom piece 40 may be 2″ thick and made of a cross-linked polyethylene foam, or vinyl coated urethane. The bottom piece 40 will be non-abrasive to the surface of the actual vehicle.

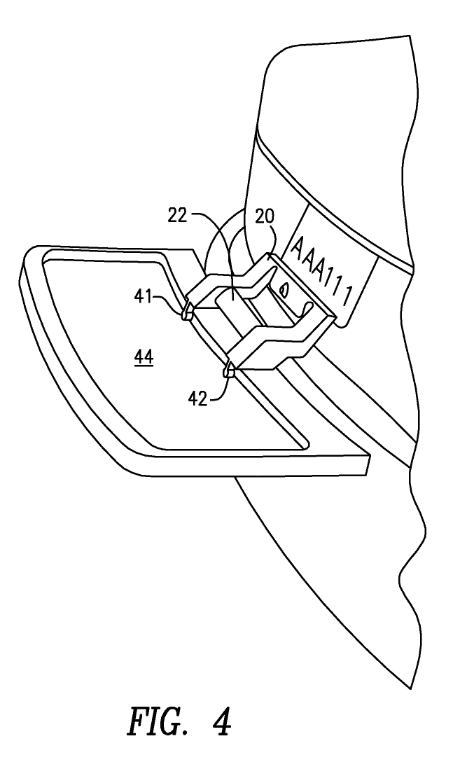

Referring now to FIG. 4 there is shown a tailgate platform 44 which is attached to piece 20 in the same manner as piece 40 is attached to piece 20. The tailgate platform 44 can be used by a car owner for tailgating activities such as occur at football games or other sporting activities, or as a work surface for any other activity. It is to be understood that platform 44 can be of various shapes, other than the shape shown in FIG. 4, and can also include such additional features as cup holders or a built in ice chest.

The bumper guard embodiment of the present invention provides a barrier of protection to the rear bumper of recent model vehicles, but may be modified to protect front bumpers. The bumper guard can be easily attached to the vehicle, stored and removed. The method of attachment of the first piece of the bumper guard also provides the possibility of alternative embodiments, including a “tailgate tray platform” that attaches using the “T” connection system and many other types of attachments.

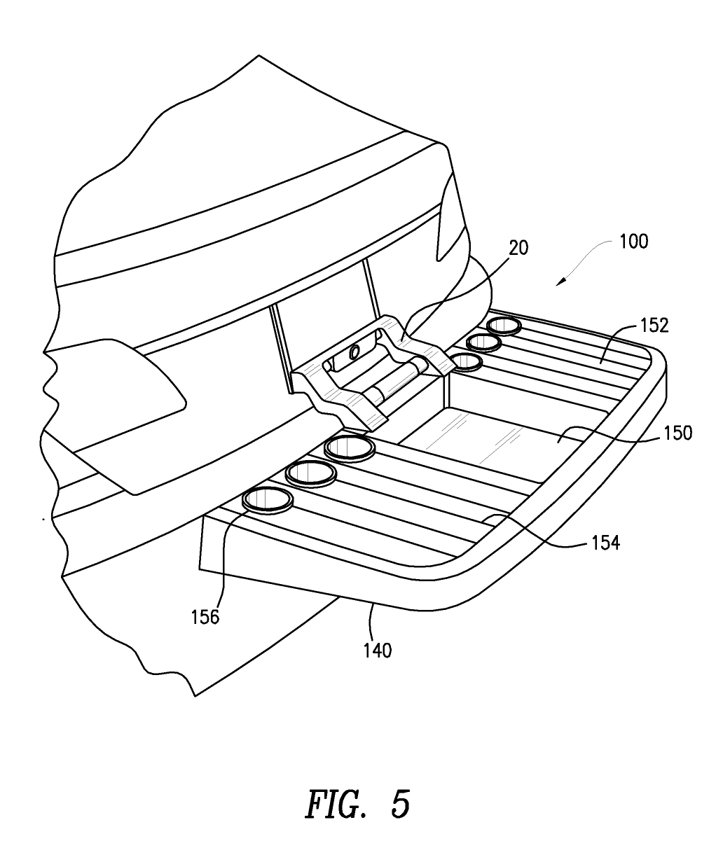

FIG. 5 shows another tailgate tray device 100 including the first piece 20 and a tray 140. Tray 140 is another embodiment of tailgate platform 44. The tray 140 has a cavity 150 flanked by doors 152, 154 and a plurality of holders 156. The cavity 150 may be used as an ice chest or to receive articles such as a portable burner and the like. The doors 152, 154 provide a horizontal planar surfaces on which to lay food, drinks or utensils. The holders 156 are dimensioned and configured to hold a variety of containers such as drink containers or condiment containers as well as receive utensils and napkins. The holders 156 may be disposed near the rear of the tray 140 adjacent the bumper of an automobile or near the front of the tray 140 away from the bumper.

Each door 152, 154 may be pivotally attached to edges of the tray 140 to conceal internal compartments lying below the doors (not shown). When the doors 152, 154 are unencumbered with articles, they may be lifted to allow users access the compartments below. In some embodiments, the tray 140 may be removably attached to the first piece 20 similar to platform 44 and bottom piece 40 described above while in other embodiments the tray 140 may be fixed to the first piece 20. In some embodiments legs or a brace may be removably fixed to the tray 140 to provide added support during use. The tray 140 may use “T” connection system or any other types of attachment means to connect to the first piece 20. In some embodiments, the tray 140 could be fixed to the first piece.

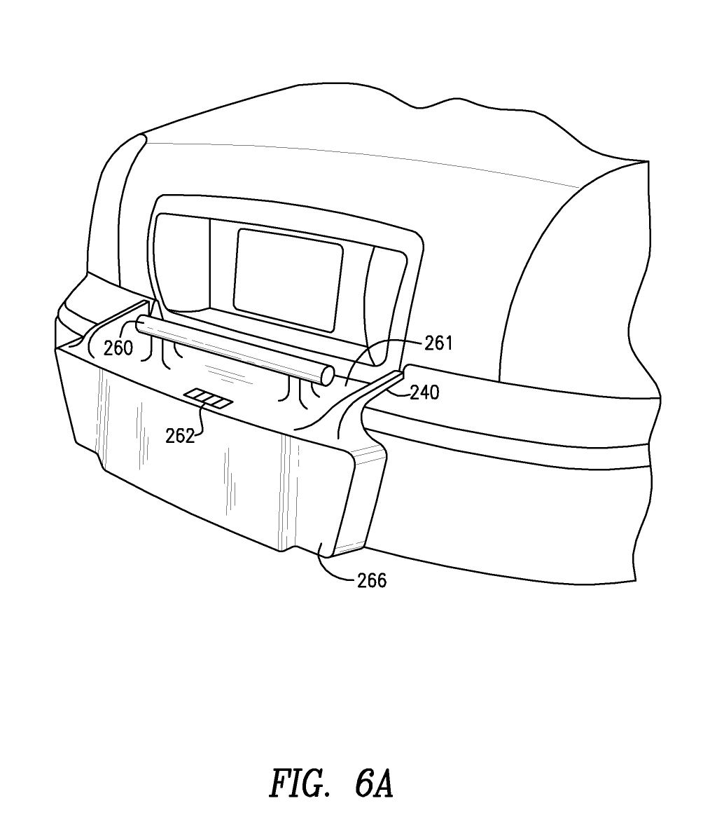

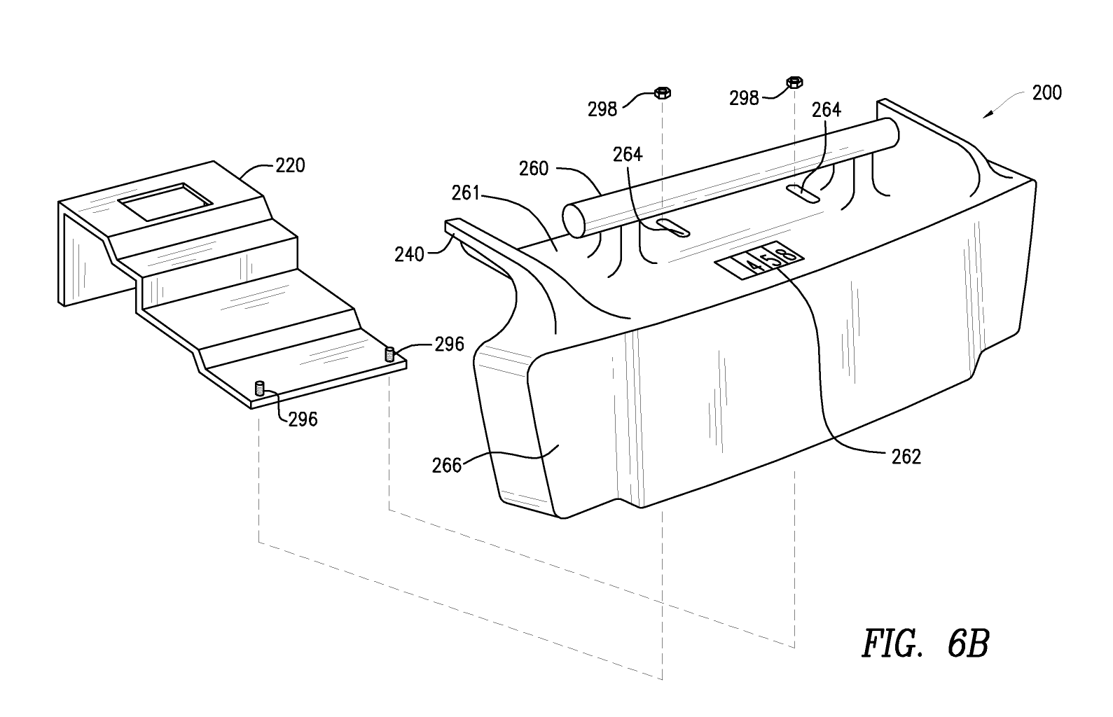

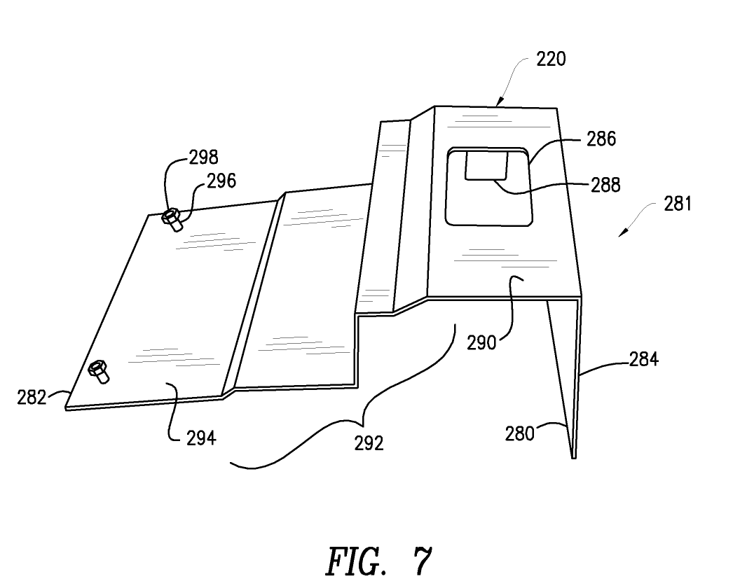

FIGS. 6A-8 show an alternative embodiment of the present invention including a first piece being a support bracket 220 and a second piece or bottom piece 240. The first piece 220 has a contoured portion 281, a stepped portion 292 and a plane portion 294 disposed between a first end 280 and a second end 282. The contoured portion 281 has a depending piece 284 disposed adjacent to a top 290. See FIGS. 6B and 7. The stepped portion 292 is disposed on the opposite side of the top 290 with the plane 294 extending therefrom. The stepped portion 292 may be dimensioned and configured to extend over and rest on the bumper of the vehicle and serves to extend the plane 294 at a workable distance to receive the bottom piece 240. Plane 294 cooperates with the bottom piece 240 using connection means that include and are not limited to nuts 298 and bolts 296.

Referring now to FIGS. 6B, 7 and 8, the contoured portion 281 rests over the back rim of a car trunk. The top 290 of the contoured portion 281 has an opening 286 designed to rest over a lock of a automobile trunk without impeding the normal functioning of the trunk lock and thereby the normal operation of the automobile trunk. Guides 288 may depend vertically from the opening 286 to position the first piece 220 on the trunk lock. With the contoured portion 281 in place, the stepped portion 292 rests over the rear bumper thereby positioning the plane 294 to readily receive the bottom piece 240.

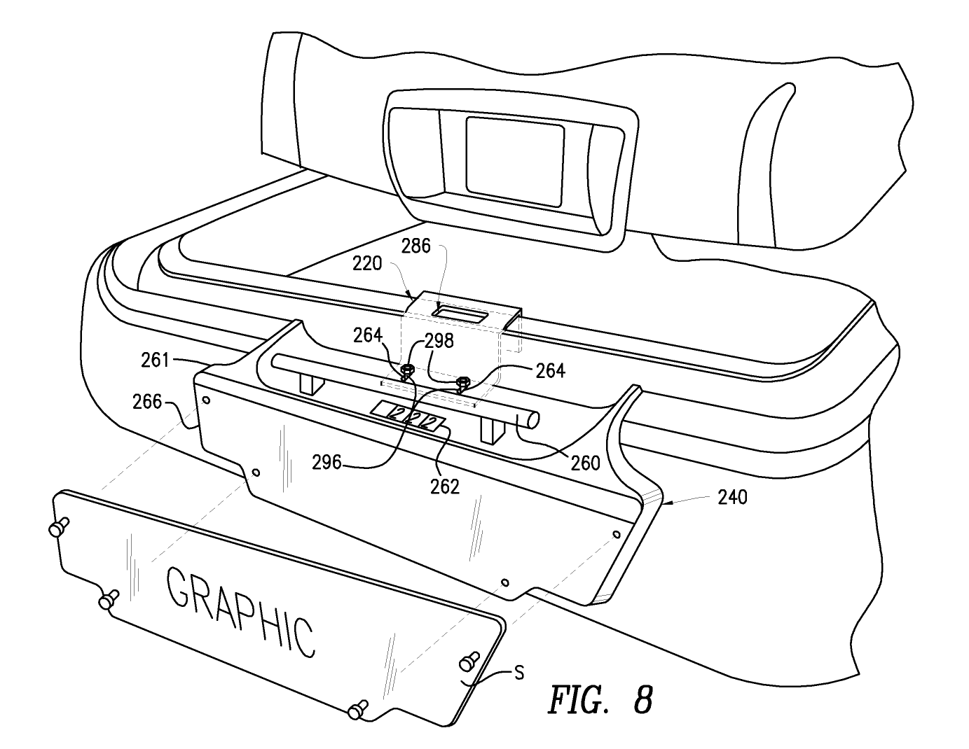

Referring now to FIGS. 6B and 8, the bottom piece 240 has a supporting member 261 and a depending member 266. The supporting member 261 has openings 264, indicia display 262 and retains a handle 222. The indicia display 262 provides a place to exhibit numbers, letters or other identification. For instance, the indicia display 262 may show the identification number of a taxi/limousine car service. The openings 264 cooperate with the connection means 296, 298 of the first piece 220. The openings 264 receive bolts 296 of the first piece 220, which are placed under the bottom piece 240. The bolts 296 are then removably fixed using the nuts 298. The bottom piece 240 may be easily placed on the plane 294 of the first piece 220 using the handle 222, which is nestled into the bottom piece 240.

When the bottom piece 240 is properly positioned on the rear of an automobile, the top surface, or top plane, of the handle 222 is aligned and level with the trunk rim, specifically a plane of the trunk rim that bears a lock of said trunk on which the top 290 of the first piece 220 is disposed. The handle 222 therefore provides an area on which items such as luggage may be loaded into the trunk of an automobile without harming the rear of the car. Also the handle 222 may be used as a luggage leveler for luggage that must extend outside or does not fit entirely within the trunk.

The depending member 266 hangs from the supporting member 261 to rest over the vehicles rear bumper and protect the bumper, similar to the bottom piece 40. The depending member 266 like bottom piece 40 may be made of foam or other suitable material to deflect damage to the underlying bumper. In a preferred embodiment, the device 200 including first piece 220 and second piece 240 may be designed for use with luxury limousines such as and not limited to Lincoln Towncar and the like.

The first piece 220 need not be limited for use with the first piece bottom piece 240. It should be noted that each the second piece 40, platform 44 and tray 140 could be modified to receive and work with the first piece 220 and not just first piece 20 as described above. For instance, when the tray 140 is modified for use with first piece 220, the tray 140 is balanced on the rim of the rear bumper and further supported by the force placed on the first piece 220 disposed between the trunk lid and the trunk rim when the trunk lid is closed and locked to the chassis of the vehicle. In other embodiments, legs or a brace may be removably fixed to the tray 140 to provide added support to the tray 140 during use.

It should also be noted that each the second piece 40, 240, platform 44 and tray 140 could receive advertising indicia thereon such as and not limited to advertising, trademarks, designs, patterns, logos, artistic and commercial expression thereon. For instance, surfaces of the second piece 240 may display advertising indicia thereon by being directly imprinted with advertising indicia. For instance, one place to display advertising would be on the depending portion 266 of the second piece 240, see FIGS. 6A and 6B. Alternatively, a rear surface of a generally transparent screen S may be digitally printed and then mechanically affixed to the surface 266 of the depending member 240, see FIG. 8. Other methods of displaying advertising indicia on depending member 266 include trapping graphics between the depending member 266 and a clear panel (not shown), attaching a 3D laminate to the depending member 266 (not shown), and other methods suitable in the art. Likewise, the second piece 40, platform 44, and tray 140 could receive advertising indicia thereon using the methods described. For instance, the doors 152, 154 of tray 140 could be decorated with advertising logos or logos of sporting teams.

Other attachments to the car bumper are also possible with the present invention including bicycle or other types of storage racks, storage containers, advertising displays, animal carriers or any other type of attachment useful to the vehicle owner.

While the present invention has been described in conjunction with specific embodiments, those of normal skill in the art will appreciate the modifications and variations can be made without departing from the scope and the spirit of the present invention. Such modifications and variations is envisioned to be within the scope of the appended claims.

I claim:

1. A system for connecting attachments to a vehicle comprising:
a first member being removably attachable to existing license plate attachment points of said vehicle; and
a second member depending from the first member, said second member disposed adjacent a bumper of said vehicle.

2. The system of claim 1 wherein said first member has a locking mechanism to secure the first member to license plate connections.

3. The system of claim 2, wherein said locking mechanism is a cam and rod connection that removably attaches to lower license plate connections of said vehicle.

4. The system of claim 1 said first member being removably attachable to said second member using a “T” locking system.

5. The system of claim 1 wherein said second member displays advertising indicia thereon.

6. The system of claim 1 wherein said second member extends in a substantially horizontal plane in a rearward direction from the rear of said vehicle, said second member having at least one internal compartment, wherein an interior of said compartment is selectively concealed using at least one door, said door permitting selective access within each said compartment

7. The system of claim 6 wherein said second member is a tray, said tray having a central cavity, said central cavity being flanked by two internal compartments.

8. The system of claim 1 wherein said second member is dimensioned and configured to protect a rear bumper of a vehicle, said second member having an indicia display.

9. The system of claim 1 wherein said second member has a handle disposed on a top section of said second member, a top plane of said handle being aligned with a plane of said trunk rim that bears a lock of said trunk.

10. A system for connecting attachments to a vehicle comprising:
a first member being removably attachable to a trunk rim of a vehicle;
a second member depending from the first member, said second member disposed adjacent a bumper of a vehicle.

11. The system of claim 10 wherein said first member is a bracket, said bracket being dimensioned and configured to fit over the trunk rim, said bracket having an opening dimensioned and configured to rest over a lock of said trunk without encumbering normal functioning of said lock.

12. The system of claim 11 wherein said bracket has a contoured portion and a plane end, said contoured portion being dimensioned and configured to fit over the trunk rim, said contoured portion having an opening dimensioned and configured to rest over a lock of said trunk without encumbering normal functioning of said lock, said plane end having connection means to removably receive said second member.

13. The system of claim 10 said first member being removably attachable to said second member using a “T” locking system.

14. The system of claim 10 wherein said second member displays advertising indicia thereon.

15. The system of claim 10 wherein said second member extends in a substantially horizontal plane in a rearward direction from the rear of said vehicle, said second member being a tray, said tray having at least one internal compartment, wherein an interior of said compartment is selectively concealed using a door.

16. The system of claim 10 wherein said second member is dimensioned and configured to protect a rear bumper of a vehicle, said second member having an indicia display.

17. The system of claim 10 wherein said second member has a handle disposed on a top section of said second member, a top plane of said handle being aligned with a plane of said trunk rim that bears a lock of said trunk.

18. A bumperguard device comprising:
a bracket being removably attachable to a trunk rim of a vehicle;
a second member depending from the first member, said second member disposed adjacent a bumper of a vehicle.

19. The bumperguard device of claim 18, wherein said bracket has a first contoured end and a second plane end, said contoured portion being dimensioned and configured to fit over the trunk rim, said contoured portion having an opening dimensioned and configured to rest over a lock of said trunk without encumbering normal functioning of said lock, said plane end having connection means to removably receive said second member.

20. The bumperguard device of claim 18, wherein said second member is dimensioned and configured to protect a rear bumper of said vehicle, said second member having an indicia display, said second member displaying advertising indicia thereon, said second member having a handle disposed on a top section of said second member, a top plane of said handle being aligned with a plane of said trunk rim on which a lock of said trunk is disposed.

21. A tailgate accessory comprising
a first connection member, said first connection member removably attachable to a vehicle;
and
a second member depending from the first connection member, said second member disposed adjacent a bumper of a vehicle, said second member extending in a substantially horizontal plane in a rearward direction from the rear of said vehicle.

22. The tailgate device of claim 21, wherein said first connection member has a cam and rod connection to removably attach to two lower license plate connections of said vehicle.

23. The tailgate device of claim 21, wherein said first connection member is a bracket having a first contoured end and a second plane end, said contoured portion being dimensioned and configured to fit over the trunk rim, said contoured portion having an opening dimensioned and configured to rest over a lock of said trunk without encumbering normal functioning of said lock, said plane end having connection means to removably receive said second member.
